(19) United States
(12) Patent Application Publication
(10) Pub. No.: US 2006/0198439 A1
(43) Pub. Date: Sep. 7, 2006

(54) Method and system for mode decision in a video encoder

(76) Inventor: Qin-fan Zhu, Acton, MA (US)

Correspondence Address: MCANDREWS HELD & MALLOY, LTD, 500 WEST MADISON STREET, SUITE 3400, CHICAGO, IL, 60661, US

(21) Appl. No.: 11/070,469

(22) Filed: Mar. 1, 2005

(51) Int. Cl. H04N 11/04; H04B 1/66; H04N 7/12; H04N 11/02

(52) U.S. Cl. 375/240.03; 375/240.18; 375/240.23

(57) ABSTRACT

Described herein is a method and system for encoding video data. Mode decision during video encoding is based on optimization of rate and distortion. This optimization is efficiently accomplished by using a look-up table of rate-distortion parameters necessary for cost generation. The relationship between rate and distortion may change over time. Therefore, this rate-distortion table may be updated.

### RELATED APPLICATIONS

[Not Applicable]

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

Video communications systems are continually being enhanced to meet requirements such as reduced cost, reduced size, improved quality of service, and increased data rate. The ITU-T Video Coding Experts Group (VCEG) and the ISO/IEC Moving Picture Experts Group (MPEG) have drafted a video coding standard titled ITU-T Recommendation H.264 and ISO/IEC MPEG-4 Advanced Video Coding (H.264). H.264 includes spatial prediction, temporal prediction, transformation, interlaced coding, and lossless entropy coding.

Although many advanced processing techniques are available, the design of an H.264 compliant video encoder and the method of selecting encoding modes are not specified in the standard. Optimization of the communication system's requirements is dependent on the design of the video encoder.

Limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein are system(s) and method(s) for encoding video data, substantially as shown in and/or described in connection with at least one of the figures, as set forth more completely in the claims.

These and other advantages and novel features of the present invention will be more fully understood from the following description.

### BRIEF DESCRIPTION OF THE DRAWINGS

FIG. 1 is a block diagram of an exemplary picture in the H.264 coding standard in accordance with an embodiment of the present invention;

FIG. 2 is a block diagram describing temporally encoded macroblocks in accordance with an embodiment of the present invention;

FIG. 3 is a block diagram of frame/field encoding of macroblocks in accordance with an embodiment of the present invention;

FIG. 4 is a block diagram describing spatially encoded macroblocks in accordance with an embodiment of the present invention;

FIG. 5 is a block diagram describing the transformation and quantization of a prediction in accordance with an embodiment of the present invention;

FIG. 6 is a block diagram of an exemplary video encoding system in accordance with an embodiment of the present invention;

FIG. 7 is a block diagram of an exemplary mode decision engine in accordance with an embodiment of the present invention; and

FIG. 8 is a flow diagram of an exemplary method for video encoding in accordance with an embodiment of the present invention.

### DETAILED DESCRIPTION OF THE INVENTION

According to certain aspects of the present invention, a system and method for mode decision in a video encoder are presented.

H.264 Video Coding Standard

The ITU-T Video Coding Experts Group (VCEG) and the ISO/IEC Moving Picture Experts Group (MPEG) drafted a video coding standard titled ITU-T Recommendation H.264 and ISO/IEC MPEG-4 Advanced Video Coding, which is incorporated herein by reference for all purposes. In the H.264 standard, video is encoded on a macroblock-by-macroblock basis. The generic term “picture” is used throughout this specification to refer to frames, fields, slices, blocks, macroblocks, or portions thereof.

The specific algorithms used for video encoding and compression form a video-coding layer VCL, and the protocol for transmitting the VCL is called the Network Access Layer (NAL). The H.264 standard allows a clean interface between the signal processing technology of the VCL and the transport-oriented mechanisms of the NAL, so no source-based encoding is necessary in networks that may employ multiple standards.

By using the H.264 compression standard, video can be compressed while preserving image quality through a combination of spatial, temporal, and spectral compression techniques. To achieve a given Quality of Service (QoS) within a small data bandwidth, video compression systems exploit the redundancies in video sources to de-correlate spatial, temporal, and spectral sample dependencies. Statistical redundancies that remain embedded in the video stream are distinguished through higher order correlations via entropy coders. Advanced entropy coders can take advantage of context modeling to adapt to changes in the source and achieve better compaction.

An H.264 encoder can generate three types of coded pictures: Intra-coded (I), Predictive (P), and Bi-directional (B) pictures. An I picture is encoded independently of other pictures based on a transformation, quantization, and entropy coding. I pictures are referenced during the encoding of other picture types and are coded with the least amount of compression. P picture coding includes motion compensation with respect to the previous I or P picture. A Bpicture is an interpolated picture that requires both a past and a future reference picture (I or P). The picture type I uses the exploitation of spatial redundancies while types P and B use exploitations of both spatial and temporal redundancies. Typically, I pictures require more bits than P pictures, and P pictures require more bits than B pictures. After coding, the frames are arranged in a deterministic periodic sequence, for example “IBBPBB” or “IBBPBBPBBPBB”, which is called Group of Pictures (GOP).

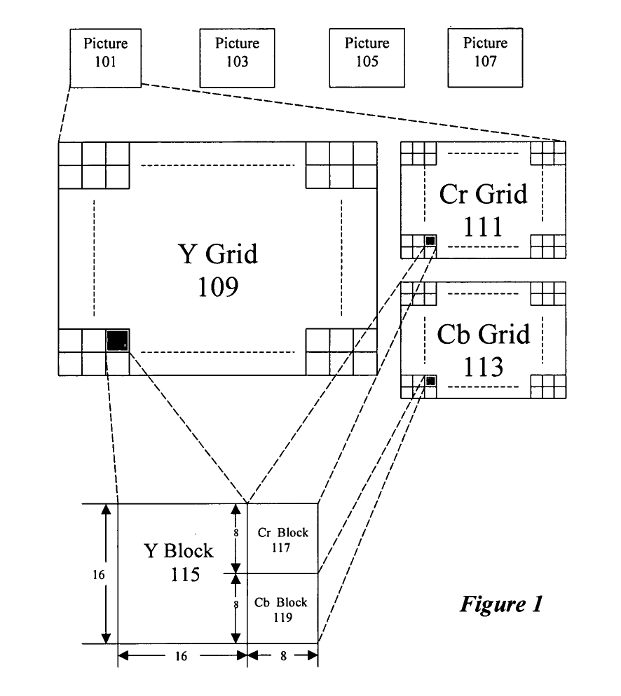

Referring now to FIG. 1, there is illustrated a block diagram of an exemplary picture 101. The picture 101 along with successive pictures 103, 105, and 107 form a video sequence. The picture 101 comprises two-dimensional grid(s) of pixels. For color video, each color component is associated with a unique two-dimensional grid of pixels. For example, a picture can include luma, chroma red, and chroma blue components. Accordingly, these components are associated with a luma grid 109, a chroma red grid 111, and a chroma blue grid 113. When the grids 109, 111, 113 are overlayed on a display device, the result is a picture of the field of view at the duration that the picture was captured.

Generally, the human eye is more perceptive to the luma characteristics of video, compared to the chroma red and chroma blue characteristics. Accordingly, there are more pixels in the luma grid 109 compared to the chroma red grid 111 and the chroma blue grid 113. In the MPEG 4:2:0 standard, the chroma red grid 111 and the chroma blue grid 113 have half as many pixels as the luma grid 109 in each direction. Therefore, the chroma red grid 111 and the chroma blue grid 113 each have one quarter as many total pixels as the luma grid 109.

The luma grid 109 can be divided into 16×16 pixel blocks. For a luma block 115, there is a corresponding 8×8 chroma red block 117 in the chroma red grid 111 and a corresponding 8×8 chroma blue block 119 in the chroma blue grid 113. Blocks 115, 117, and 119 are collectively known as a macroblock that can be part of a slice group. Currently, 4:2:0 subsampling is the only color space used in the H.264 specification. This means, a macroblock consist of a 16×16 luminance block 115 and two (subsampled) 8×8 chrominance blocks 117 and 118.

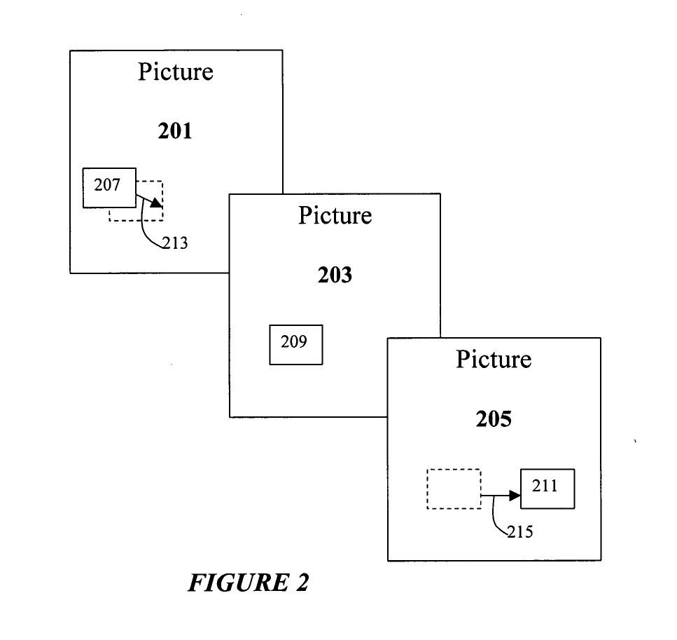

Referring now to FIG. 2, there is illustrated a block diagram describing temporally encoded macroblocks. In bi-directional coding, a current partition 209 in the current picture 203 is predicted from a reference partition 207 in a previous picture 201 and a reference partition 211 in a latter arriving picture 205. Accordingly, a prediction error is calculated as the difference between the weighted average of the reference partitions 207 and 211 and the current partition 209. The prediction error and an identification of the prediction partitions are encoded. Motion vectors 213 and 215 identify the prediction partitions.

The weights can also be encoded explicitly, or implied from an identification of the picture containing the prediction partitions. The weights can be implied from the distance between the pictures containing the prediction partitions and the picture containing the partition.

To provide high coding efficiency, video coding standards such as H.264 may allow a video encoder to adapt the mode of motion estimation based on the content of the video data. In H.264, the video encoder may use macroblock adaptive frame/field MBAFF coding.

In MBAFF coding, the coding is at the macroblock pair level. Two vertically adjacent macroblocks are split into either pairs of two field or frame macroblocks. For a macroblock pair that is coded in frame mode, each macroblock contains frame lines. For a macroblock pair that is coded in field mode, the top macroblock contains top field lines and the bottom macroblock contains bottom field lines. Since a mixture of field and frame macroblock pairs may occur within an MBAFF frame, encoding processes such as transformation, estimation, and quantization are modified to account for this mixture.

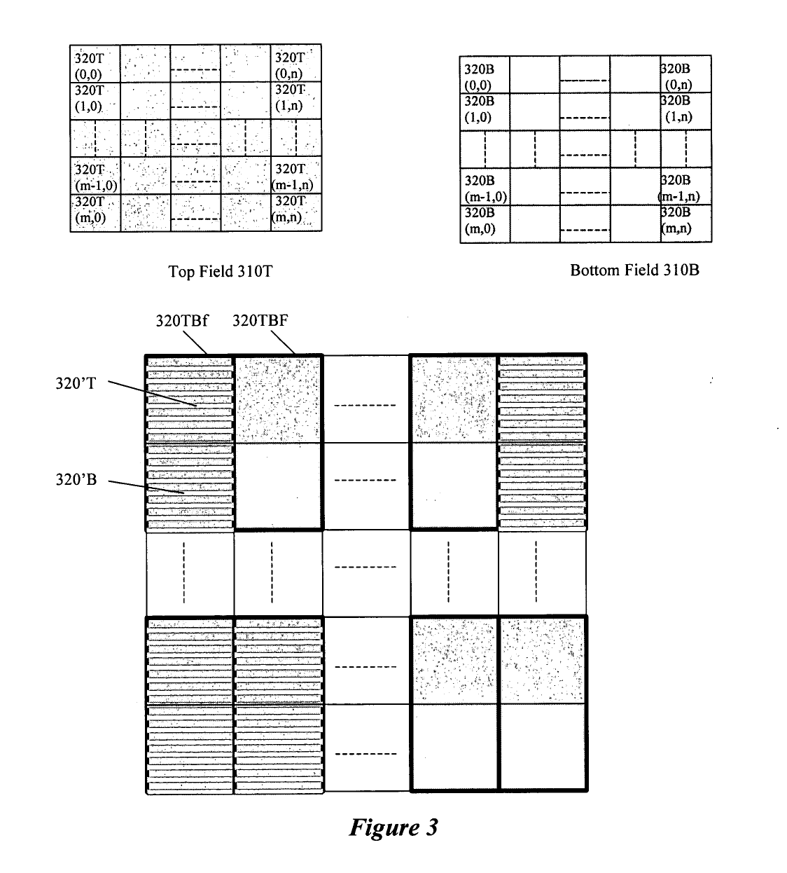

Referring now to FIG. 3, there is illustrated a block diagram describing the encoding of macroblocks 320 for interlaced fields. As noted above, interlaced fields, top field 310T(x,y) and bottom field 310B(x,y) represent either even or odd-numbered lines.

In MBAFF, each macroblock 320T in the top frame is paired with the macroblock 320B in the bottom frame that is interlaced with it. The macroblocks 320T and 320B are then coded as a macroblock pair 320TB. The macroblock pair 320TB can either be field coded, i.e., macroblock pair 320TBF or frame coded, i.e., macroblock pair 320TBf. Where the macroblock pair 320TBF are field coded, the macroblock 320T is encoded, followed by macroblock 320B. Where the macroblock pair 320TBf are frame coded, the macroblocks 320T and 320B are deinterlaced. The foregoing results in two new macroblocks 320′T, 320′B. The macroblock 320′T is encoded, followed by macroblock 320′B.

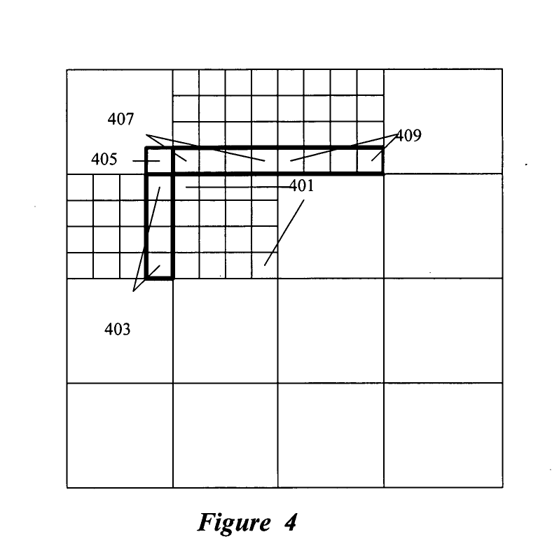

Referring now to FIG. 4, there is illustrated a block diagram describing spatially encoded macroblocks. Spatial prediction, also referred to as intraprediction, involves prediction of picture pixels from neighboring pixels. The pixels of a macroblock can be predicted, in a 16×16 mode, an 8×8 mode, or a 4×4 mode. A macroblock is encoded as the combination of the prediction errors representing its partitions.

In the 4×4 mode, a macroblock 401 is divided into 4×4 partitions. The 4×4 partitions of the macroblock 401 are predicted from a combination of left edge partitions 403, a corner partition 405, top edge partitions 407, and top right partitions 409. The difference between the macroblock 401 and prediction pixels in the partitions 403, 405, 407, and 409 is known as the prediction error. The prediction error is encoded along with an identification of the prediction pixels and prediction mode.

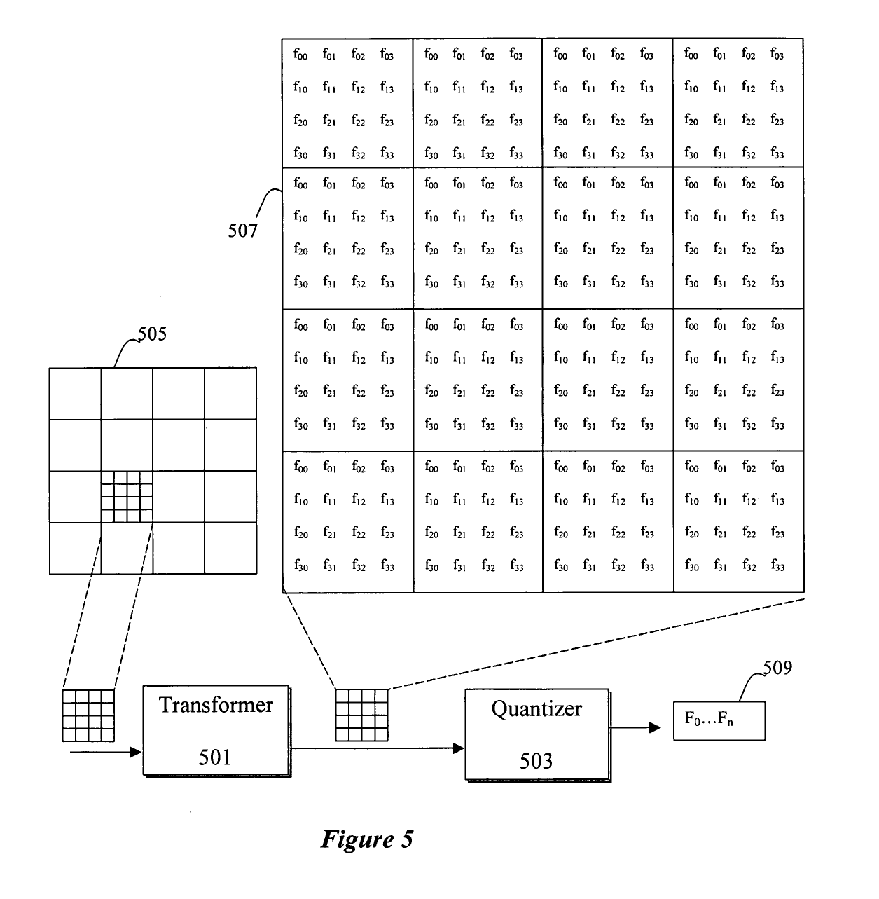

Referring now to FIG. 5, there is illustrated a block diagram describing the transformation and quantization of the prediction parameters. A macroblock is encoded as the combination of its partitions. A macroblock is represented by an error for both spatial prediction and temporal prediction. The prediction error is also a two-dimensional grid of pixel values for the luma Y, chroma red Cr, and chroma blue Cb components with the same dimensions as the macroblock.

The transformer 501 transforms 4×4 partitions of the prediction parameters 505 to the frequency domain, thereby resulting in corresponding sets of frequency coefficients 507. The sets of frequency coefficients 507 are then passed to a quantizer 503, resulting in set of quantized frequency coefficients, F₀ . . . Fₙ 509. The quantizer 509 can be programmed with one of the variable quantization levels.

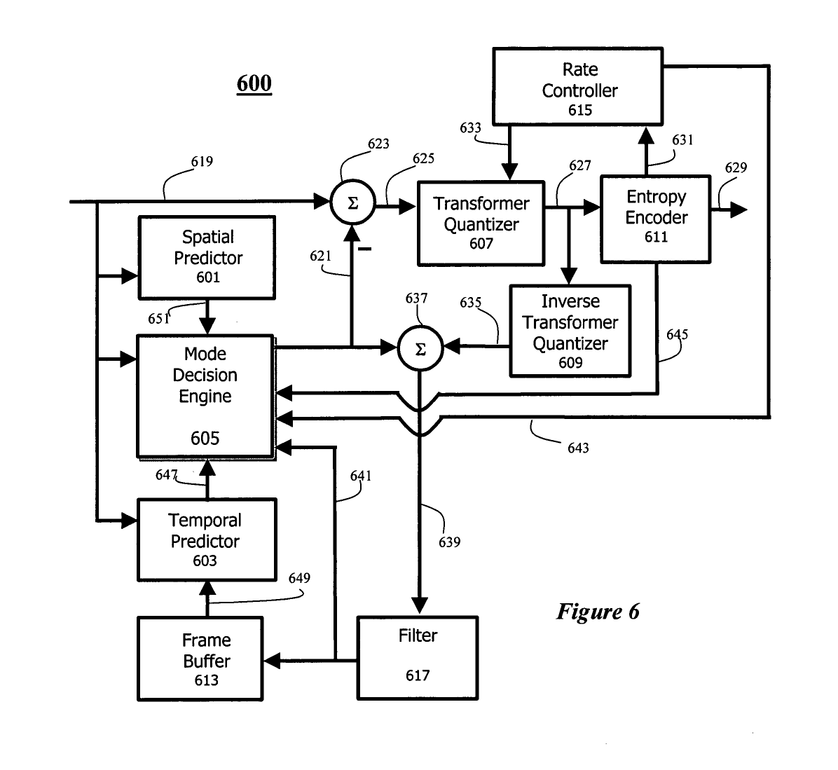

In FIG. 6 a block diagram of a video encoding system 600 is presented. The video encoding system 600 comprises a Spatial Predictor 601, a Temporal Predictor 603, a Mode Decision Engine 605, a Transformer/Quantizer 607, an Inverse Transformer/Quantizer 609, an Entropy Encoder 611, a Frame Buffer 613, a Rate Controller 615, and a Filter. The Mode Decision Engine 605 can search possible modes of spatial predictors 651 and temporal predictors 647 to determine the least encoding cost.

Spatial Predictor 601

Spatial prediction is based only on content of the current picture. The spatial predictor 601 receives a current picture 619 and produces spatial predictors 651.

Spatially predicted pictures are Intra-coded. Luma macroblocks can be divided into 4×4 partitions or 16×16 partitions. There are 9 prediction modes available for 4×4 macroblocks and 4 prediction modes available for 16×16 macroblocks. Chroma macroblocks are 8×8 partitions and have 4 possible prediction modes.

Temporal Predictor 603

In temporal prediction (i.e. motion estimation), the current picture 619 is estimated from reference pictures 649 using a set of motion vectors 647. The Temporal Predictor 603 receives the current picture 619 and a set of reference pictures 649 that are stored in a Frame Buffer 613. A temporally encoded macroblock can be divided into 16×8, 8×16, 8×8, 4×8, 8×4, or 4×4 partitions. Each partition of a macroblock is compared to one or more prediction partitions in another picture(s) that may be temporally located before or after the current picture. Motion vectors describe the spatial displacement between partitions and identify the prediction partition(s).

Transformer/Quantizer

Once the mode is selected, a corresponding prediction error 625 is the difference 623 between the current picture 619 and the selected prediction 621. A macroblock is encoded as the combination of the prediction errors 625 representing its partitions. In the case of temporal prediction, the prediction error 625 is transformed along with the motion vectors.

Transformation utilizes Adaptive Block-size Transforms (ABT). The block size used for transform coding of the prediction error 625 corresponds to the block size used for prediction. The prediction error is transformed independently of the block mode by means of a low-complexity 4×4 matrix that together with an appropriate scaling in the quantization stage approximates the 4×4 Discrete Cosine Transform (DCT). The Transform is applied in both horizontal and vertical directions. When a macroblock is encoded as intra 16×16, the DC coefficients of all 16 4×4 blocks are further transformed with a 4×4 Hadamard Transform.

The transformed values are quantized according to a quantizer level 633. There may be a total of 52 quantizer levels. Quantization may include Frequency-based Rounding, wherein a frequency with low perceptual value will be more likely to be rounded or clipped.

Entropy Encoder 611

MPEG-4 specifies two types of entropy coding: Context-based Adaptive Binary Arithmetic Coding (CABAC) and Context-based Adaptive Variable-Length Coding (CAVLC). CABAC produces the most efficient compression, especially for high color images. CAVLC runs synchronously to the main encoding loop while CABAC runs asynchronously to the main encoding loop.

CAVLC receives the quantized transform coefficients 627 and scans them in a zigzag manner prior to entropy encoding and generating a video output 629.

CABAC includes Binarization, Context Model Selection, Arithmetic Encoding, and Context Model Updating. Quantized transform coefficients 627 are reduced in range to create symbols of one's and zeros for each input value. Binarization converts non-binary-valued symbols into binary codes prior to Arithmetic Encoding. The result of Binarization is called a bin string or bins. Context Model Selection is used to determine an accurate probability model for one or more bins of the bin string. The Context Modeler samples the input bins and assigns probability models based on a frequency of observed bins. This model may be chosen from a selection of available models depending on the statistics of recently coded data symbols. The Context Model stores the probability of each bin being “1” or “0”. With Arithmetic Encoding each bin is encoded according to the selected context model. There are just two sub-ranges for each bin: corresponding to “0” and “1”. A mapping engine utilizes the context model and assigns bits to input bins. Generated bits are to be embedded in an outgoing video stream 629. Context model updating is based on the actual coded value (e.g. if the bit value was “1”, the frequency count of “1”s is increased). The same generated bits that are to be embedded in the outgoing video stream are fed back to context modeling to update probabilities of observed events.

The quantized transform coefficients 627 are also fed into an inverse quantizer/transformer 609 in order to regenerate reference pictures 641 that are stored in the frame buffer 613. The original prediction 621 and a regenerated error 635 are summed 637. The result 639 is passed through a Filter 617 to remove blocking effects prior to being stored.

Rate Controller 615

Rate control loops are the feedback mechanisms that monitor and adjust bandwidth allocation. Rate control can stabilize spatial and temporal complexity based on bit allocation at the macroblock level, the slice level, or the group of pictures level.

The current bandwidth utilization 631 is measured based on the number of bits (or estimated number of bits) in the video output 629.

Mode Decision Engine 605

The Mode Decision Engine 605 will select the prediction mode according to a cost optimization that in turn is based on the encoded rate and distortion for each block and each prediction mode. This mode selection is based on rate-distortion optimization.

The Mode Decision Engine 605 receives all modes of temporal predictors 647 and spatial predictors 651. The mode selector 605 can select the prediction mode according a rate-distortion optimization criterion that is based on the encoded rate and distortion for each block and each prediction mode.

An issue in rate-distortion optimization is to obtain the actual coding rate and distortion for the candidate coding modes. The coding rate and distortion for each coding mode can be obtained by actual encoding of the macroblock with the coding mode. Having many candidate coding modes can make actual encoding very costly to implement, and often, the cost is unacceptable. Hence, the current invention will find the approximation of the rate and distortion based on the prediction error for each coding mode and the quantization parameter to be used for encoding the current macroblock.

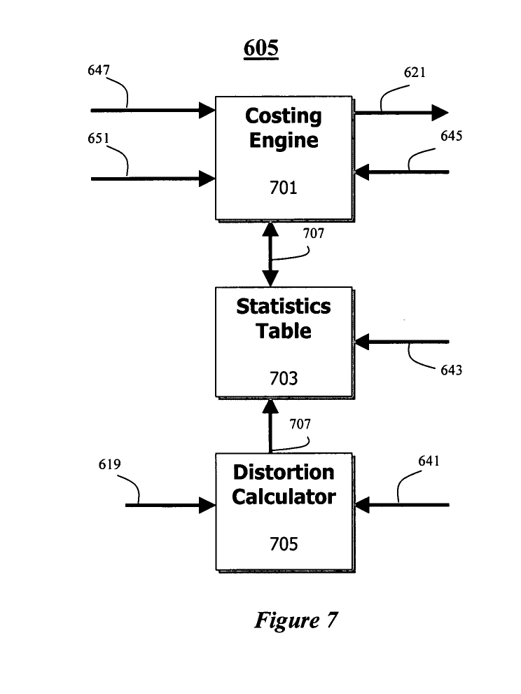

Referring now also to FIG. 7. The Mode Decision Engine 605 comprises a Costing Engine 701, a Statistics Table 703, and a Distortion Calculator 705.

Costing Engine 701

The Costing Engine 701 is the part of the Mode Decision Engine 605 that receives the modes of temporal predictors 647, spatial predictors 651, and prediction errors. The prediction corresponding to the mode with the optimum cost will be output 621.

Cost can be function of rate and distortion parameters (Cost=f(distortion, rate)). As mentioned above, the rate and distortion can be obtained after encoding with the given mode. However, the introduced complexity may be so great that this method may not be acceptable, and alternatively, the estimates of rate and distortion can be used for the cost calculation. The cost J for mode n is given below:
Jₙ=D(SATD,QP)+λ(R_{mode}+R_{mvd}+R(SATD,QP))
λ=0.85*2^{((QP-12)/6)}

R_{mode} is the number of VLC mode bits associated with choosing mode. R_{mvd} is the number of bits for coding all the motion vectors of the 16×16 macroblock. R_{mode} and R_{mvd} can be input 645 from the Entropy Encoder 611. R and D can be accessed 707 from the Statistics Table 703 according to quantization parameter (QP) and sum of absolute transformed difference (SATD), which is the sum of absolute difference of the prediction error after a transform. The said transform can be the Hadamard transform.

Distortion Calculator 705

D(SATD,QP) 707 is computed in the Distortion Calculator 705 as the sum of squared differences (SSDRecon) between the current picture 619 and a reconstructed picture 641. The encoding process that creates the reconstructed picture 641 from the current picture 619 has a set of encoding parameters comprising a quantization level QP and a distortion parameter SATD.

Statistics Table 703

Accessing rate and distortion stored in the Statistics Table 703 enables mode selection. For each given mode, the rate and distortion are found by the QP and SATD for that mode. Interpolation of table entries can be used to yield higher precision, and account for a limited number of entries. For improved performance, there can also be separate tables for I, P, and B macroblock types.

R and D vary depending on content. The Statistics Table 703 may be adapted over time to update rate-distortion metrics as video content changes. After encoding each macroblock, bits 643 and SSDRecon 707 are used to update the RD table. Updating a table element (X) can be accomplished the following way:
X_{new}=α*X_{old}+(1−α)*X_{current}
0<a<1

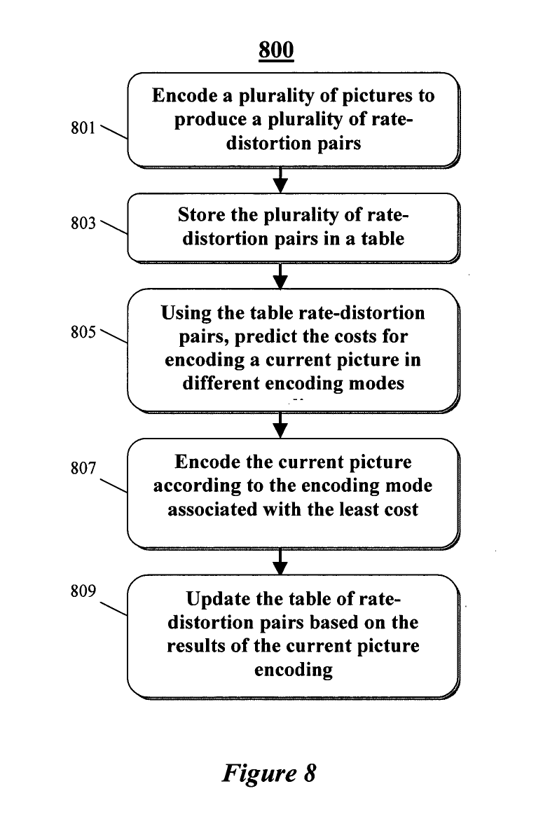

FIG. 8 is a flow diagram of an exemplary method for deciding the mode while video encoding in accordance with an embodiment of the present invention.

Encode a plurality of pictures to produce a plurality of rate-distortion pairs at 801. The encoding comprises spatial or temporal prediction of a current picture, error generation, transformation of the error, quantization of the transformed error, and entropy encoding. The rate is bit usage at the entropy encoder output. The distortion is the sum of squared differences between the current picture and a picture that is reconstructed from the encoded prediction.

Store the plurality of rate-distortion pairs in a table at 803. Using the table rate-distortion pairs, predict the costs for encoding a current picture in different encoding modes at 805. Completing the encoding process accurately generates rate and distortion, but may not be computationally feasible for every mode decision that can be made. Rate and distortion are functions of the quantization level and the prediction error. Since the quantization level and the prediction error can be computed without completing the encoding process, these parameters can be used to access a prestored table of rate-distortion pairs in order to compute cost.

Encode the current picture according to the encoding mode associated with the least cost at 807. Update the table of rate-distortion pairs based on the results of the current picture encoding at 809. Since video content changes and the entropy encoder adapts bit allocation, the look-up method of cost generation and mode selection is optimized by adapting table entries over time.

The embodiments described herein may be implemented as a board level product, as a single chip, application specific integrated circuit (ASIC), or with varying levels of a video classification circuit integrated with other portions of the system as separate components. An integrated circuit may store a supplemental unit in memory and use an arithmetic logic to encode, detect, and format the video output.

The degree of integration of the video classification circuit will primarily be determined by the speed and cost considerations. Because of the sophisticated nature of modern processors, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware as instructions stored in a memory. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on MPEG-1 encoded video data, the invention can be applied to a video data encoded with a wide variety of standards.

Therefore, it is intended that the present invention not be limited to the particular embodiment disclosed, but that the present invention will include all embodiments falling within the scope of the appended claims.

1. A method for mode decision in a video encoder, said method comprising:
encoding a plurality of pictures, thereby producing a plurality of rate-distortion pairs;
predicting one or more costs for encoding a current portion of a picture, wherein each cost is based on one of the plurality of rate-distortion pairs and an encoding mode is associated with each cost; and
encoding the current portion of the picture based on the particular encoding mode, thereby producing a current rate-distortion pair.

2. The method of claim 1, wherein the particular encoding mode is associated with the least cost.

3. The method of claim 1, wherein the method further comprises:
updating the plurality of rate-distortion pairs based on the current rate-distortion pair.

4. The method of claim 1, wherein the method further comprises:
storing the plurality of rate-distortion pairs in a table.

5. The method of claim 4, wherein the table indices are a quantization number and an error metric.

6. The method of claim 5, wherein the quantization number is one of a group of quantization levels in accordance with a compression standard.

7. The method of claim 6, wherein the error metric is the sum of absolute differences in pixel level between the current portion of the picture and a predicted portion of the picture.

8. The method of claim 7, wherein the current portion of the picture and the predicted portion of the picture are represented in a transform domain.

9. The method of claim 1, wherein the cost is a sum of the reference distortion and a rate value scaled by a coefficient, wherein the coefficient is a function of a quantization level and the rate value is the sum of the reference bit usage, a mode bit usage, and a vector bit usage.

10. A system for mode decision in a video encoder, said system comprising:
an entropy encoder for producing a plurality of bits from a first picture encoded according to an encoding mode and a quantization level, wherein the plurality of bits comprises a reference bit usage;
a distortion calculator for calculating a reference distortion of the first picture encoded according to the encoding mode and the quantization level;
a statistics table for storing the reference bit usage and the reference distortion; and
a costing engine for predicting a cost for encoding a second picture based on the reference bit usage and the reference distortion.

11. The system of claim 10, wherein the reference bit usage is updated by a current bit usage, wherein a quantization number and an error metric associated with the reference bit usage are substantially equal to a quantization number and an error metric associated with the current bit usage.

12. The system of claim 11, wherein the quantization number is one of a group of quantization levels in accordance with a compression standard.

13. The system of claim 11, wherein the error metric is the sum of absolute differences in pixel level between a current picture and a predicted picture.

14. The system of claim 13, wherein the current picture and the predicted picture are represented in a transform domain.

15. The system of claim 10, wherein the cost is a sum of the reference distortion and a rate value scaled by a coefficient, wherein the coefficient is a function of the quantization level and the rate value is the sum of the reference bit usage, a mode bit usage, and a vector bit usage.

16. An integrated circuit for video encoding, said integrated circuit comprising:
a circuit operable for encoding a first plurality of pictures and determining the least cost for encoding a second plurality of pictures; and
a memory for storing a table of rate-distortion statistics according to the encoding of the first plurality of pictures, wherein the table is accessible for determining a cost.

17. The integrated circuit of claim 16, wherein the circuit is further operable for:
encoding the second plurality of pictures; and
updating the table of rate-distortion statistics according to the encoding of the second plurality of pictures.

18. The integrated circuit of claim 16, wherein the table indices are a quantization number and an error metric.
